(19) United States
(12) Patent Application Publication
(10) Pub. No.: US 2014/0323379 A1
(43) Pub. Date: Oct. 30, 2014

(54) WASHING AND CLEANING AGENTS CONTAINING GLYCERIN ESTERS

(71) Applicant: Henkel AG & Co. KGaA, Duesseldorf (DE)

(72) Inventors: Nina Mussmann, Willich (DE); Thomas Eiting, Duesseldorf (DE); Christian Kropf, Hilden (DE); Konstantin Benda, Duesseldorf (DE); Thorsten Bastigkeit, Wuppertal (DE)

(21) Appl. No.: 14/328,918

(22) Filed: Jul. 11, 2014

Related U.S. Application Data
(63) Continuation of application No. PCT/EP2012/065253, filed on Aug. 3, 2012.

(30) Foreign Application Priority Data
Jan. 12, 2012 (DE) 10 2012 200 402.5

(51) Int. Cl. C11D 3/20

(52) U.S. Cl. CPC C11D 3/2093
USPC 510/229

(57) ABSTRACT

It has been discovered according to the present invention that glycerol esters effectively prevent or at least decrease the discoloration of plastic dishes in the context of automatic dishwashing.

### FIELD OF THE INVENTION

The present invention generally relates to washing and cleaning agents, and more particularly relates to automatic dishwashing agents, containing glycerol esters to prevent the discoloration of plastic dishes, to methods for automatic dishwashing using said dishwashing agents, and to the use of the dishwashing agents to prevent the discoloration of plastic dishes.

### BACKGROUND OF THE INVENTION

When discolorations occur on plastic in the course of automatic dishwashing, they usually result from very intensely colored foods such as curry, paprika, tomatoes, red cabbage, ketchup, carrots, etc. that are introduced into the automatic dishwasher in the form of food residues. Discolorations of plastic, for example of plastic dishes, result in dissatisfaction on the part of the consumer, since although the relevant plastic dishes remain unimpaired on a purely functional level, they appear to many consumers to be visually degraded, or at least the aesthetic perception is disrupted.

Compounds to decrease the discoloration of plastics are described, for example, in EP application 1373450. This discloses that copolymers based on hydrophobically modified polycarboxylates suppress the discoloration of plastic dishes.

WO 2010/078979 discloses the use of porous polyamide particles, and of synthetic sheet silicates, to decrease the discoloration of plastic dishes.

The object of the present invention was therefore to furnish alternative compounds that at least decrease the occurrence of discolorations on plastics in the course of automatic dishwashing as a consequence of colored food residues.

This object is achieved by glycerol esters.

The mono- and diesters of glycerol (also referred to as mono- and diglycerides) occur, for example, as breakdown products of dietary fats in the context of fat digestion (lipolysis).

Glycerol esters are employed chiefly as emulsifier agents in the production of baked goods and pastries, chocolate products, margarines, infant food, cocoa powder, milk powder, mashed potatoes, rice, and noodles.

It has been found, surprisingly, that these compounds represent effective inhibitors of plastics discoloration.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A washing or cleaning agent containing at least one glycerol ester, characterized in that the glycerol in the glycerol ester is esterified with one or two branched or unbranched, saturated or unsaturated C₅₋₂₁ fatty acids.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A first subject of the present invention is therefore washing and cleaning agents that contain glycerol esters, wherein the glycerol in the glycerol ester is esterified with one or two branched or unbranched, saturated or unsaturated C₅₋₂₁ fatty acids, preferably C₁₂₋₂₀ fatty acids, particularly preferably C₁₆₋₂₀ fatty acids. If the ester bond is formed with only one C₅₋₂₁ fatty acid, the ester bond is preferably formed with a terminal hydroxy group of the glycerol.

In a preferred embodiment, the remaining hydroxy groups of the glycerol ester, which are not esterified with a C₅₋₂₁ fatty acid, are unoccupied.

In a further preferred embodiment at least one further hydroxy group of the glycerol ester, preferably exactly one hydroxy group of the glycerol ester, is esterified with a C₂₋₆ carboxylic acid.

The C₂₋₆ carboxylic acid to be employed according to the present invention preferably comprises further hydrophilic groups, in particular carboxy groups and/or hydroxy groups, and preferably up to two further carboxy groups (besides the carboxy group that forms the ester bond with the glycerol) and/or up to 5 hydroxy groups. The C₂₋₆ carboxylic acid is selected according to the present invention particularly preferably from acetic acid, propionic acid, lactic acid, oxalic acid, citric acid, isocitric acid, tartaric acid, tartronic acid, glycolic acid, malic acid, and gluconic acid.

In an embodiment particularly preferred according to the present invention, the glycerol ester is a compound in which the glycerol is esterified on the one hand with a branched or unbranched, saturated or unsaturated C₅₋₂₁ fatty acid, preferably C₁₂₋₂₀ fatty acid, particularly preferably C₁₆₋₂₀ fatty acid, especially a C₁₈ fatty acid, and on the other hand with a hydrophilically modified C₂₋₆ carboxylic described previously. In this preferred embodiment, both ester bonds are preferably formed terminally.

Esters of glycerol that are usable according to the present invention are obtainable commercially, for example, under the commercial name Grindsted (Danisco), in particular under the commercial names Grindsted® Acetem, Grindsted® Citrem, Grindsted® Mono-Di, and Grindsted® Lactem.

The glycerol ester is contained in washing and cleaning agents according to the present invention preferably in a quantity from 0.05 to 30 wt %, in particular 0.1 to 10 wt %, particularly preferably 0.5 to 5 wt %.

In a preferred embodiment, the washing or cleaning agent according to the present invention is an automatic dishwashing agent.

The washing and cleaning agent according to the present invention, in particular the automatic dishwashing agent according to the present invention, preferably contains at least one further constituent, preferably at least two further constituents, selected from the group consisting of builders, surfactants, polymers, bleaching agents, bleach activators, enzymes, glass corrosion inhibitors, corrosion inhibitors, disintegration adjuvants, scents, and perfume carriers.

A further subject of the present invention is the use of a washing or cleaning agent according to the present invention, in particular of an automatic dishwashing agent according to the present invention, to prevent and/or reduce the color staining of plastic and/or to avoid a change in the color impression of plastic dishes, in particular when they are cleaned in an automatic dishwasher.

A further subject of the present invention is an automatic dishwashing method characterized in that a washing or cleaning agent according to the present invention, in particular an automatic dishwashing agent according to the present invention, is employed in particular for the purpose of decreasing and/or preventing the discoloration of plastics.

It has been found, surprisingly, that the above-described glycerol esters make it possible largely to prevent, or appreciably to reduce, the discoloration of plastic materials during the automatic dishwashing process. The change in the color impression of plastic dishes when they are cleaning in an automatic dishwasher can be avoided or at least reduced. The transfer of dyes, resulting from colored food residues, into plastic dishes when they are cleaned in an automatic dishwasher can be suppressed or at least reduced. Transfer of the following dyes can be particularly effectively inhibited or at least reduced:
orange-red carotenoids such as lycopene or beta-carotene, for example from tomatoes, ketchup, or carrots,
yellow curcuma dyes such as curcumin, for example from curry and mustard.

Transfer of the following dyes can optionally also be inhibited:

red to blue anthocyan dyes, e.g. cyanidin, for example from cherries or blueberries,
red betanidin, for example from red beets,
brown tannins, for example from tea, fruit, red wine,
dark brown humic acid, for example from coffee, tea, cocoa,
green chlorophyll, for example from green vegetables.

White and light-colored plastic materials, in particular, benefit from the invention. In a preferred embodiment, the plastic materials are made of polyethylene or polypropylene.

An agent according to the present invention can additionally contain if desired, besides the active agents recited, a further known color transfer inhibitor, and this then preferably in quantities from 0.01 wt % to 5 wt %, in particular 0.1 wt % to 1 wt %. In a preferred embodiment of the invention, for example, a polymer of vinylpyrrolidone, vinylimidazole, vinylpyridine-N-oxide, or a copolymer of them, is usable. Also usable are polyvinylpyrrolidones having molecular weights from 15,000 to 50,000, as well as polyvinylpyrrolidones having molecular weights over 1,000,000, in particular from 1,500,000 to 4,000,000, N-vinylimidazole/N-vinylpyrrolidone copolymers, polyvinyloxazolidones, polyamine-N-oxide polymers, polyvinyl alcohols, and copolymers based on acrylamidoalkenylsulfonic acids.

For use in agents according to the present invention, polyvinylpyrrolidone preferably has an average molar mass in the range from 10,000 to 60,000, in particular in the range from 25,000 to 50,000. Among the copolymers, those of vinylpyrrolidone and vinylimidazone at a molar ratio from 5:1 to 1:1, having an average molar mass in the range from 5000 to 50,000, in particular 10,000 to 20,000, are preferred.

Porous polyamide particles and/or synthetic sheet silicates can be used as further known color transfer inhibitors.

It is also possible, however, to employ enzymatic systems comprising a peroxidase and hydrogen peroxide or a substance that yields hydrogen peroxide in water. The addition of a mediator compound for the peroxidase, for example an acetosyringone, a phenol derivative, or a phenothiazine or phenoxazine, is preferred in this case, wherein aforementioned conventional polymeric color-transfer-inhibiting active substances can also be additionally used.

The dishwashing agents according to the present invention, which can be solid or liquid and can be present in particular as powdered solids, in recompressed particle form, or as homogeneous solutions or suspensions, can in principle contain, besides the ingredients employed according to the present invention, all known ingredients that are usual in such agents; substances from the group of builders, surfactants, polymers, bleaching agents, bleach activators, enzymes, glass corrosion inhibitors, corrosion inhibitors, disintegration adjuvants, scents, and perfume carriers, are particularly preferred. These and further preferred ingredients are in part described in further detail later.

A further subject of the invention consists in the use of the previously described glycerol esters to prevent the discoloration of plastic materials during the automatic dishwashing process. “Preventing the discoloration of plastic materials during the automatic dishwashing process” means here that the degree of discoloration of plastic materials is at least reduced; in the best case the discoloration of plastic materials is entirely suppressed.

A further subject of the present invention consists in the use of the previously described glycerol esters to prevent the transfer of dyes, resulting from colored food residues, onto plastic dishes upon cleaning thereof in an automatic dishwasher. “Preventing the transfer of dyes onto plastic dishes” means here that the degree of transfer of dyes onto plastic dishes is at least reduced; in the best case the transfer of dyes onto plastic dishes is entirely suppressed.

A further subject of the present invention consists in the use of the previously described glycerol esters to prevent a change in the color impression of plastic dishes upon cleaning thereof in an automatic dishwasher. “Preventing a change in the color impression of plastic dishes” means here that the degree of change in the color impression is at least reduced; in the best case the change in color impression is entirely suppressed.

The preceding sections of the description apply to the aforementioned uses and methods in terms of the glycerol esters that can be employed.

Possible ingredients that can advantageously be employed in the automatic dishwashing agents according to the present invention will be described below.

Builders can be used with advantage. Included among the builders are in particular zeolites, silicates, carbonates, organic co-builders, and—where no environmental prejudices against their use exist—also phosphates.

Crystalline sheet silicates of the general formula NaMSiₓO₂ₓ₊₁.yH₂O can be used with preference, where M represents sodium or hydrogen, x a number from 1.9 to 22, preferably from 1.9 to 4, particularly preferred values for x being 2, 3, or 4, and y denotes a number from 0 to 33, preferably from 0 to 20. The crystalline sheet silicates of the formula NaMSiₓO₂ₓ₊₁.yH₂O are marketed, for example, by Clariant GmbH (Germany) under the trade name Na-SKS. Examples of these silicates are Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O), or Na-SKS-4 (Na₂Si₄O₉.xH₂O, makatite).

Crystalline sheet silicates of the formula NaMSiₓO₂ₓ₊₁.yH₂O in which x denotes 2 are particularly suitable for purposes of the present invention. Both β- and δ-sodium disilicates Na₂Si₂O₅.yH₂O, as well as also principally Na-SKS-5 (α-Na₂Si₂O₅), Na-SKS-natrosilite), Na-SKS-9 (NaHSi₂O₅.H₂O), Na-SKS-10 (NaHSi₂O₅.3H₂O, kanemite), Na-SKS-11 (t-Na₂Si₂O₅), and Na-SKS-13 (NaHSi₂O₅), but in particular Na-SKS-6 (δ-Na₂Si₂O₅), are particularly preferred.

Automatic dishwashing agents preferably contain a weight proportion of the crystalline sheet silicates of the formula NaMSiₓO₂ₓ₊₁.yH₂O from 0.1 to 20 wt %, preferably from 0.2 to 15 wt %, and in particular from 0.4 to 10 wt %, based in each case on the total weight of said agents.

Also usable are amorphous sodium silicates having a Na₂O:SiO₂ modulus from 1:2 to 1:3.3, preferably from 1:2 to 1:2.8, and in particular from 1:2 to 1:2.6, which are preferably dissolution-delayed and exhibit secondary washing properties. The dissolution delay as compared with conventional amorphous sodium silicates can have been brought about in various ways, for example by surface treatment, compounding, compacting/densification, or overdrying. The term “amorphous” is understood in the context of this invention to mean that in X-ray diffraction experiments the silicates do not yield the sharp X-ray reflections that are typical of crystalline substances, but produce at most one or more maxima in the scattered X radiation that have a width of several degree units of the diffraction angle.

Alternatively or in combination with the aforesaid amorphous sodium silicates, it is possible to use X-amorphous silicates whose silicate particles yield blurred or even sharp diffraction maxima in electron beam diffraction experiments. This is to be interpreted to mean that the products comprise microcrystalline regions 10 to several hundred nm in size, values of up to a maximum of 50 nm, and in particular up to a maximum of 20 nm, being preferred. X-amorphous silicates of this kind likewise exhibit a dissolution delay as compared with conventional water glasses. Densified/compacted amorphous silicates, compounded amorphous silicates, and overdried X-amorphous silicates are particularly preferred.

It is preferred in the context of the present invention for this/these silicate(s), preferably alkali silicates, particularly preferably crystalline or amorphous alkali disilicates, to be contained in washing and cleaning agents in quantities from 3 to 60 wt %, preferably from 8 to 50 wt %, and in particular from 20 to 40 wt %, based in each case on the weight of the automatic dishwashing agent.

Utilization of the commonly known phosphates as builder substances is also possible, provided such use is not to be avoided for environmental reasons. Among the plurality of commercially obtainable phosphates, the alkali-metal phosphates have the greatest significance in the washing- and cleaning-agent industry, with particular preference for pentasodium or pentapotassium triphosphate (sodium or potassium tripolyphosphate).

“Alkali-metal phosphates” is the summary designation for the alkali-metal (in particular sodium and potassium) salts of the various phosphoric acids, in which context a distinction can be made between metaphosphoric acids (HPO₃)ₙ and orthophosphoric acid H₃PO₄, in addition to higher-molecular-weight representatives. The phosphates embody a combination of advantages: they act as alkali carriers, prevent lime deposits on machine parts or lime incrustations in fabrics, and furthermore contribute to cleaning performance.

Phosphates that are technically especially important are pentasodium triphosphate Na₅P₃O₁₀ (sodium tripolyphosphate) and the corresponding potassium salt pentapotassium triphosphate K₅P₃O₁₀ (potassium tripolyphosphate). Sodium potassium tripolyphosphates are also preferably usable.

If phosphates are employed in the context of the present Application in automatic dishwashing agents as substances having washing or cleaning activity, preferred agents then contain that/those phosphate(s), preferably alkali-metal phosphate(s), particularly preferably pentasodium or pentapotassium triphosphate (sodium or potassium tripolyphosphate), in quantities from 5 to 80 wt %, preferably from 15 to 75 wt %, and in particular from 20 to 70 wt %, based in each case on the weight of the automatic dishwashing agent.

Alkali carriers are further builders. Alkali-metal hydroxides, alkali-metal carbonates, alkali-metal hydrogen carbonates, alkali-metal sesquicarbonates, the aforesaid alkali silicates, alkali metasilicates, and mixtures of the aforesaid substances are considered, for example, to be alkali carriers; the alkali carbonates, in particular sodium carbonate, sodium hydrogen carbonate, or sodium sesquicarbonate, can preferably be used for purposes of this invention. A builder system containing a mixture of tripolyphosphate and sodium carbonate is particularly preferred. Also particularly preferred is a builder system containing a mixture of tripolyphosphate and sodium carbonate and sodium disilicate. Because of their low chemical compatibility with the other ingredients of automatic dishwashing agents as compared with other builder substances, the optional alkali-metal hydroxides are preferably used only in small quantities, preferably in quantities below 10 wt %, preferably below 6 wt %, particularly preferably below 4 wt %, and in particular below 2 wt %, based in each case on the total weight of the automatic dishwashing agent. Agents that contain, based on their total weight, less than 0.5 wt % and in particular no alkali-metal hydroxides, are particularly preferred.

It is particularly preferred to use carbonate(s) and/or hydrogen carbonate(s), preferably alkali carbonate(s), particularly preferably sodium carbonate, in quantities from 2 to 50 wt %, preferably from 5 to 40 wt %, and in particular from 7.5 to 30 wt %, based in each case on the weight of the automatic dishwashing agent. Agents that contain, based on the weight of the automatic dishwashing agent, less than 20 wt %, preferably less than 17 wt %, preferably less than 13 wt %, and in particular less than 9 wt % carbonate(s) and/or hydrogen carbonate(s), preferably alkali carbonate(s), particularly preferably sodium carbonate, are particularly preferred.

Organic co-builders that are to be recited are in particular polycarboxylates/polycarboxylic acids, polymeric polycarboxylates, aspartic acid, polyacetals, dextrins, further organic co-builders, as well as phosphonates. These substance classes will be described below.

Usable organic builder substances are, for example, polycarboxylic acids that can be utilized, for example, in the form of the free acid and/or sodium salts thereof, “polycarboxylic acids” being understood as those carboxylic acids which carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. The free acids typically also possess, besides their builder effect, the property of an acidifying component, and thus also serve to establish a lower and milder pH for the automatic dishwashing agents. To be recited in this context are, in particular, citric acid, succinic acid, glutaric acid, adipic acid, gluconic acid, and any mixtures thereof.

The use of citric acid and/or citrates in agents according to the present invention has proven to be particularly advantageous for the cleaning and rinsing performance of said agents. Automatic dishwashing agents characterized in that the automatic dishwashing agent contains citric acid or a salt of citric acid, and that the weight proportion of citric acid or the salt of citric acid is preferably more than 10 wt %, by preference more than 15 wt %, and in particular between 20 and 40 wt %, are therefore preferred according to the present invention.

Polymeric polycarboxylates are also suitable as builders; these are, for example, the alkali-metal salts of polyacrylic acid or of polymethacrylic acid, for example those having a relative molecular weight from 500 to 70,000 g/mol.

The molar masses indicated for polymeric polycarboxylates are, for purposes of this document, weight-average molar masses M_{w} of the respective acid form that were determined in principle by means of gel permeation chromatography (GPC), a UV detector having been used. The measurement was performed against an external polyacrylic acid standard that yields realistic molecular weight values because of its structural affinity with the polymers being investigated. These indications deviate considerably from the molecular weight indications in which polystyrenesulfonic acids are used as a standard. The molar masses measured against polystyrenesulfonic acids are as a rule much higher than the molar masses indicated in this document.

Suitable polymers are, in particular, polyacrylates that preferably have a molecular weight from 2000 to 20,000 g/mol. Of this group in turn, the short-chain polyacrylates, which have molar masses from 2000 to 10,000 g/mol and particularly preferably from 3000 to 5000 g/mol, can be preferred because of their superior solubility.

Also suitable are copolymeric polycarboxylates, in particular those of acrylic acid with methacrylic acid and of acrylic acid or methacrylic acid with maleic acid. Copolymers of acrylic acid with maleic acid that contain 50 to 90 wt % acrylic acid and 50 to 10 wt % maleic acid have proven particularly suitable. Their relative molecular weight, based on free acids, is generally 2000 g/mol to 70,000 g/mol, preferably 20,000 g/mol to 50,000 g/mol, and in particular 30,000 g/mol to 40,000 g/mol.

The (co)polymeric polycarboxylates can be employed either as a powder or as an aqueous solution. The concentration of (co)polymeric polycarboxylates in automatic dishwashing agents is preferably 0.5 to 20 wt %, and in particular 3 to 10 wt %.

To improve water solubility, the polymers can also contain allylsulfonic acids, for example allyloxybenzenesulfonic acid and methallylsulfonic acid, as monomers.

Also particularly preferred are biodegradable polymers made up of more than two different monomer units, for example those that contain as monomers salts of acrylic acid and of maleic acid as well as vinyl alcohol or vinyl alcohol derivatives, or that contain as monomers salts of acrylic acid and of 2-alkylallylsulfonic acid, as well as sugar derivatives.

Further preferred copolymers are those that comprise acrolein and acrylic acid/acrylic acid salts, or acrolein and vinyl acetate, as monomers.

Polymers effective as water softeners are, for example, the sulfonic-acid-group-containing polymers, which can be used with particular preference.

Particularly preferred for use as sulfonic-acid-group-containing polymers are copolymers of unsaturated carboxylic acids, sulfonic-acid-group-containing monomers, and optionally further ionic or nonionogenic monomers.

With particular preference, the automatic dishwashing agents according to the present invention contain methylglycinediacetic acid or a salt of methylglycinediacetic acid, wherein the weight proportion of methyglycinediacetic acid or of the salt of methylglycinediacetic acid is preferably between 0.5 and 15 wt %, by preference between 0.5 and 10 wt %, and in particular between 0.5 and 6 wt %.

All compounds that are capable of forming complexes with alkaline-earth-metal ions can furthermore be used as builders.

The agents according to the present invention can contain surfactants; the nonionic, anionic, cationic, and amphoteric surfactants are included in the group of surfactants.

All nonionic surfactants known to one skilled in the art can be used as nonionic surfactants. Suitable nonionic surfactants are, for example alkylglycosides of the general formula RO(G)ₓ in which R corresponds to a primary straight-chain or methyl-branched aliphatic residue, in particular methyl-branched in the 2-position, having 8 to 22, preferably 12 to 18 carbon atoms, and G is the symbol that denotes a glycose unit having 5 or 6 carbon atoms, preferably glucose. The degree of oligomerization x, which indicates the distribution of monoglycosides and oligoglycosides, is any number between 1 and 10; x is preferably 1.2 to 1.4.

A further class of nonionic surfactants used in preferred fashion, which are used either as the only nonionic surfactant or in combination with other nonionic surfactants, are alkoxylated, preferably ethoxylated or ethoxylated and propoxylated, fatty acid alkyl esters, preferably having 1 to 4 carbon atoms in the alkyl chain.

Nonionic surfactants of the amine oxide type, for example N-cocalkyl-N,N-dimethylamine oxide and N-tallowalkyl-N,N-dihydroxyethylamine oxide, and fatty acid alkanolamides, can also be used. The quantity of these nonionic surfactants is preferably equal to no more than that of the ethoxylated fatty alcohols, in particular no more than half thereof.

Further suitable surfactants are polyhydroxy fatty acid amides, also known as PHFA.

Low-foaming nonionic surfactants can be used as preferred surfactants. With particular preference, automatic dishwashing agents contain nonionic surfactants from the group of alkoxylated alcohols. Alkoxylated, advantageously ethoxylated, in particular primary alcohols having preferably 8 to 18 carbon atoms and on average 1 to 12 mol ethylene oxide (EO) per mol of alcohol, in which the alcohol residue can be linear or preferably methyl-branched in the 2-position or can contain linear and methyl-branched residues in the mixture, such as those usually present in oxo alcohol residues, are preferably used as nonionic surfactants. Particularly preferred, however, are alcohol ethoxylates having linear residues made up of alcohols of natural origin having 12 to 18 carbon atoms, e.g. from coconut, palm, tallow, or oleyl alcohol, and an average of 2 to 8 mol EO per mol of alcohol. The preferred ethoxylated alcohols include, for example, C₁₂₋₁₄ alcohols with 3 EO or 4 EO, C₉₋₁₁ alcohol with 7 EO, C₁₃₋₁₅ alcohols with 3 EO, 5, EO, 7 EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages that can correspond to an integer or a fractional number for a specific product. Preferred alcohol ethoxylates exhibit a restricted distribution of homologs (narrow range ethoxylates, NRE). In addition to these nonionic surfactants, fatty alcohols with more than 12 EO can also be used. Examples thereof are tallow fatty alcohol with 14 EO, 25 EO, 30 EO, or 40 EO.

Nonionic surfactants that have a melting point above room temperature are particularly preferred. Nonionic surfactant(s) having a melting point above 20° C., preferably above 25° C., particularly preferably between 25 and 60° C., and in particular between 26.6 and 43.3° C., is/are particularly preferred.

Surfactants that are preferably to be used derive from the groups of alkoxylated nonionic surfactants, in particular ethoxylated primary alcohols, and mixtures of these surfactants with surfactants of greater structural complexity, such as polyoxypropylene/polyoxyethylene/polyoxypropylene (PO/EO/PO) surfactants. (PO/EO/PO) nonionic surfactants of this kind are moreover notable for good foam control.

Nonionic surfactants which have proved to be particularly preferred for the purposes of the present invention are low-foaming nonionic surfactants that comprise alternating ethylene-oxide and alkylene-oxide units. Among these, surfactants with EO-AO-EO-AO blocks are in turn preferred, with in each case one to ten EO or AO groups being attached to one another before being followed by a block of the respective other groups. Preferred nonionic surfactants here are those of the general formula

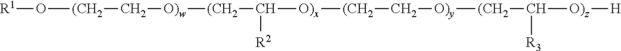

in which R¹ denotes a straight-chain or branched, saturated or mono- or polyunsaturated C₆₋₂₄ alkyl or alkenyl residue; each group R² or R³ is mutually independently selected from —CH₃, —CH₂CH₃, —CH₂CH₂—CH₃, CH(CH₃)₂ and the indices w, x, y, z mutually independently denote integers from 1 to 6.

Surfactants of the general formula

R¹—CH(OH)CH₂-(AO)_{w}-(A′O)ₓ-(A″O)_{y}-(A′″)_{z}—R², in which

R¹ and R² mutually independently denote a straight-chain or branched, saturated or mono- or polyunsaturated C₂₋₄₀ alkyl or alkenyl residue; A, A′, A″, and A′″ mutually independently denote a residue from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y, and z denote values between 0.5 and 90, where x, y, and/or z can also be 0, are particularly preferred according to the present invention.

In a preferred embodiment, very particularly preferred nonionic surfactants have the general formula R¹O[CH₂CH(CH₃)O]ₓ[CH₂CH₂O]_{y}[CH₂CH(CH₃)O]_{z}CH₂CH(OH)R² in which R¹ denotes a linear or branched aliphatic hydrocarbon residue having 4 to 22 carbon atoms, or mixtures thereof, R² designates a linear or branched hydrocarbon residue having 2 to 26 carbon atoms, in particular 4 to 20 carbon atoms, or mixtures thereof, and x and z denote values between 0 and 40 and y denotes a value of at least 15.

Also preferred are surfactants of the general formula R¹O[CH₂CH(CH₃)O]ₓ[CH₂CH₂O]_{y}CH₂CH(OH)R² in which R¹ denotes a linear or branched aliphatic hydrocarbon residue having 4 to 22 carbon atoms, or mixtures thereof, R² designates a linear or branched hydrocarbon residue having 2 to 26 carbon atoms, or mixtures thereof, and x denotes a value between 1 and 40 and y denotes a value between 15 and 40, wherein the alkylene units [CH₂CH(CH₃)O] and [CH₂CH₂O] are present in randomized fashion, i.e. in the form of a statistical, random distribution.

The carbon chain lengths, and degrees of ethoxylation or alkoxylation, indicated for the aforesaid nonionic surfactants represent statistical averages that can be an integer or a fractional number for a specific product. As a result of the manufacturing method, commercial products of the formulas recited are usually made up not of an individual representative but rather of mixtures, which can result in averages and, as a consequence thereof, fractional numbers for both the carbon chain lengths and the degrees of ethoxylation or alkoxylation.

Anionic surfactants can likewise be used as a constituent of automatic dishwashing agents. Included thereamong are, in particular, alkylbenzenesulfonates, (fatty) alkyl sulfates, (fatty) alkyl ether sulfates, and alkanesulfonates. The anionic surfactant content of the agents is usually 0 to 10 wt %.

Cationic and/or amphoteric surfactants can also be used instead of or in conjunction with the surfactants recited. Cationic active substances that can be used are, for example, cationic compounds of the following formulas:

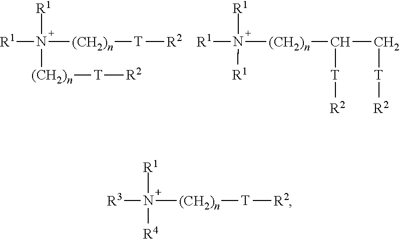

in which each group R¹ is selected mutually independently from C₁₋₆ alkyl, alkenyl, or hydroxyalkyl groups; each group R² is selected mutually independently from C₈₋₂₈ alkyl or alkenyl groups; R³=R¹ or (CH₂)ₙ-T-R²; R⁴=R¹ or R² or (CH₂)ₙ-T-R²; T=—CH₂—, —O—CO—, or —CO—O—, and n is an integer from 0 to 5.

In automatic dishwashing agents, the concentration of cationic and/or amphoteric surfactants is preferably less than 6 wt %, preferably less than 4 wt %, very particularly preferably less than 2 wt %, and in particular less than 1 wt %. Automatic dishwashing agents that contain no cationic or amphoteric surfactants are particularly preferred.

The group of polymers includes in particular the polymers having washing or cleaning activity, for example rinsing polymers and/or polymers effective as water softeners. Besides nonionic polymers, in general cationic, anionic, and amphoteric polymers are also usable in automatic dishwashing agents.

“Cationic polymers” for purposes of the present invention are polymers that carry a positive charge in the polymer molecule. This can be implemented, for example, by way of (alkyl)ammonium groupings or other positively charged groups present in the polymer chain. Particularly preferred cationic polymers derive from the groups of quaternized cellulose derivatives, polysiloxanes having quaternary groups, cationic guar derivatives, polymeric dimethyldiallylammonium salts and copolymers thereof with esters and amides of acrylic acid and methacrylic acid, copolymers of vinylpyrrolidone with quaternized derivatives of dialkylaminoacrylate and -methacrylate, vinylpyrrolidone/methoimidazolinium chloride copolymers, quaternized polyvinyl alcohols, or the polymers described by the INCI names Polyquatemium 2, Polyquatemium 17, Polyquatemium 18, and Polyquatemium 27.

“Amphoteric polymers” for purposes of the present invention further comprise, besides a positively charged group in the polymer chain, negatively charged groups or monomer units. These groups can be, for example, carboxylic acids, sulfonic acids, or phosphonic acids.

Amphoteric polymers preferred for use derive from the group of alkylacrylamide/acrylic acid copolymers, alkylacrylamide/methacrylic acid copolymers, alkylacrylamide/methylmethacrylic acid copolymers, alkylacrylamide/acrylic acid/alkylaminoalkyl(meth)acrylic acid copolymers, alkylacrylamide/methacrylic acid/alkylaminoalkyl(meth)acrylic acid copolymers, alkylacrylamide/methylmethacrylic acid/alkylaminoalkyl(meth)acrylic acid copolymers, alkylacrylamide/alkyl methacrylate/alkylaminoethyl methacrylate/alkyl methacrylate copolymers, and copolymers of unsaturated carboxylic acids, cationically derivatized unsaturated carboxylic acids, and optionally further ionic or nonionogenic monomers.

Preferably usable zwitterionic polymers derive from the group of acrylamidoalkyltrialkylammonium chloride/acrylic acid copolymers and alkali and ammonium salts thereof, acrylamidoalkyltrialkylammonium chloride/methacrylic acid copolymers and alkali and ammonium salts thereof, and methacroylethylbetaine/methacrylate copolymers.

In a particularly preferred embodiment of the present invention the polymers are present in preformulated form. Suitable for formulation of the polymers are, among others:
encapsulation of the polymers by means of water-soluble or water-dispersible coating agents, preferably by means of water-soluble or water-dispersible natural or synthetic polymers;
encapsulation of the polymers by means of water-insoluble meltable coating agents, preferably by means of water-insoluble coating agents from the group of waxes or paraffins having a melting point above 30° C.;
cogranulation of the polymers with inert carrier materials, preferably with carrier materials from the group of substances having washing or cleaning activity, particularly preferably from the group of (detergency) builders or co-builders.

Automatic dishwashing agents contain the aforesaid cationic and/or amphoteric polymers preferably in quantities between 0.01 and 10 wt %, based in each case on the total weight of the washing or cleaning agent. Those automatic dishwashing agents in which the weight proportion of the cationic and/or amphoteric polymers is between 0.01 and 8 wt %, by preference between 0.01 and 6 wt %, preferably between 0.01 and 4 wt %, particularly preferably between 0.01 and 2 wt %, and in particular between 0.01 and 1 wt %, based in each case on the total weight of the automatic dishwashing agent, are nevertheless preferred in the context of the present Application.

Bleaching agents are a substance having washing or cleaning activity that is used with particular preference. Among the compounds that serve as bleaching agents and yield H₂O₂ in water, sodium percarbonate, sodium perborate tetrahydrate, and sodium perborate monohydrate have particular significance. Other usable bleaching agents are, for example, peroxypyrophosphates, citrate perhydrates, and peracid salts or peracids that yield H₂O₂, such as perbenzoates, peroxophthalates, diperazelaic acid, phthaloimino peracid, or diperdodecanedioic acid.

Bleaching agents from the group of organic bleaching agents can furthermore also be employed. Typical organic bleaching agents are diacyl peroxides, for example dibenzoyl peroxide. Further typical organic bleaching agents are peroxy acids, wherein alkylperoxy acids and arylperoxy acids are mentioned in particular as examples. Preferred representatives are (a) peroxybenzoic acid and ring-substituted derivatives thereof, such as alkylperoxybenzoic acids, but also peroxy-α-naphthoic acid and magnesium monoperphthalate; (b) aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamidoperoxycaproic acid, N-nonenylamidoperadipic acid, and N-nonenylamidopersuccinates; and (c) aliphatic and araliphatic peroxydicarboxylic acids, such as 1,12-diperoxycarboxylic acid, 1,9-diperoxyazelaic acid, diperoxysebacic acid, diperoxybrassylic acid, diperoxyphthalic acids, 2-decyldiperoxybutane-1,4-dioic acid, N,N-terephthaloyl-di(6-aminopercaproic) acid.

Substances that release chlorine or bromine can also be used as bleaching agents. Possibilities among the suitable materials releasing chlorine or bromine are, for example, heterocyclic N-bromamides and N-chloramides, for example trichloroisocyanuric acid, tribromoisocyanuric acid, dibromoisocyanuric acid, and/or dichloroisocyanuric acid (DICA), and/or salts thereof with cations such as potassium and sodium. Hydantoin compounds, such as 1,3-dichloro-5,5-dimethylhydantoin, are likewise suitable.

Automatic dishwashing agents that contain 1 to 35 wt %, preferably 2.5 to 30 wt %, particularly preferably 3.5 to 20 wt %, and in particular 5 to 15 wt % bleaching agent, preferably sodium percarbonate, are preferred according to the present invention.

The active oxygen content of the automatic dishwashing agent, based in each case on the total weight of the agent, is preferably between 0.4 and 10 wt %, particularly preferably between 0.5 and 8 wt %, and in particular between 0.6 and 5 wt %. Particularly preferred agents have an active oxygen content above 0.3 wt %, preferably above 0.7 wt %, particularly preferably above 0.8 wt %, and in particular above 1.0 wt %.

Bleach activators are employed in automatic dishwashing agents, for example, in order to achieve an improved bleaching effect when cleaning at temperature of 60° C. and below. Compounds that, under perhydrolysis conditions, yield aliphatic peroxocarboxylic acids having preferably 1 to 10 carbon atoms, in particular 2 to 4 carbon atoms, and/or (optionally substituted) perbenzoic acid, can be used as bleach activators. Substances that carry O- and/or N-acyl groups having the aforesaid number of carbon atoms, and/or optionally substituted benzoyl groups, are suitable. Polyacylated alkylenediamines, in particular tetraacetylethylendiamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl or isononanoyl oxybenzenesulfonate (n- or iso-NOBS), carboxylic acid anhydrides, in particular phthalic acid anhydride, acylated polyvalent alcohols, in particular triacetin, ethylene glycol diacetate, and 2,5-diacetoxy-2,5-dihydrofuran, n-methyl morpholinium acetonitrile methyl sulfate (MMA), as well as acetylated sorbitol and mannitol or mixtures thereof (SORMAN), acylated sugar derivatives, in particular pentaacetylglucose (PAG), pentaacetylfructose, tetraacetylxylose, and octaacetyllactose, as well as acetylated, optionally N-alkylated glucamine and gluconolactone, and/or N-acylated lactams, for example N-benzoylcaprolactam, are preferred. Hydrophilically substituted acyl acetates and acyl lactams are likewise preferably used. Combinations of conventional bleach activators can also be used. These bleach activators can be contained preferably in quantities of up to 10 wt %, in particular 0.1 to 8 wt %, particularly 2 to 8 wt %, and particularly preferably 2 to 6 wt %, based in each case on the total weight of the bleach-activator-containing agent.

Enzymes can be used to increase the washing or cleaning performance of automatic dishwashing agents. These include in particular proteases, amylases, lipases, hemicellulases, cellulases, perhydrolases, or oxidoreductases, as well as preferably mixtures thereof. These enzymes are in principle of natural origin; proceeding from the natural molecules, improved variants are available for use in automatic dishwashing agents and can be used in correspondingly preferred fashion. Automatic dishwashing agents contain enzymes preferably in total quantities from 1×10⁻⁶ to 5 wt %, based on active protein. The protein concentration can be determined with the aid of known methods, for example the BCA method or the biuret method.

The enzymes can be employed in any form established in the existing art. This includes, for example, the solid preparations obtained by granulation, extrusion, or freeze-drying, or (in particular with liquid or gel-type agents) solutions of the enzymes, advantageously as concentrated as possible, low in water, and/or with stabilizers added.

Alternatively, for both the solid and the liquid administration form, the enzymes can be encapsulated, for example by spray drying or extrusion of the enzyme solution together with a (preferably natural) polymer or in the form of capsules, for example those in which the enzymes are enclosed as if in a solidified gel or in those of the core-shell type, in which an enzyme-containing core is coated with a protective layer that is impermeable to water, air, and/or chemicals. Further active agents, for example stabilizers, emulsifier agents, pigments, bleaches, or dyes, can additionally be applied in superimposed layers. Such capsules are applied using methods known per se, for example by vibratory or roll granulation or in fluidized bed processes. Advantageously, such granulates are low in dust, for example thanks to the application of polymeric film formers, and are shelf-stable as a result of the coating. It is furthermore possible to formulate two or more enzymes together so that a single granulate exhibits multiple enzyme activities. Preferably one or more enzymes and/or enzyme preparations, preferably solid protease preparations and/or amylase preparations, can be used in quantities from 0.1 to 5 wt %, preferably from 0.2 to 4.5 wt %, and in particular from 0.4 to 4 wt %, based in each case on the total enzyme-containing agent.

Glass corrosion inhibitors prevent the occurrence of clouding, smearing, and scratches, but also iridescence, on the glass surface of automatically cleaned glassware. Preferred glass corrosion inhibitors derive from the group of magnesium salts and zinc salts and magnesium complexes and zinc complexes. In the context of the present invention the concentration of zinc salt in automatic dishwashing agents is by preference between 0.1 and 5 wt %, preferably between 0.2 and 4 wt %, and in particular between 0.4 and 3 wt %; or the concentration of zinc in oxidized form (calculated as Zn²⁺) is between 0.01 and 1 wt %, preferably between 0.02 and 0.5 wt %, and in particular between 0.04 and 0.2 wt %, based in each case on the total weight of the glass-corrosion-inhibitor-containing agent.

In order to facilitate the breakdown of prefabricated shaped elements, it is possible to incorporate disintegration adjuvants, so-called tablet bursting agents, into these agents in order to shorten breakdown times. “Tablet bursting agents” or “breakdown accelerators” are understood as adjuvants that ensure rapid breakdown of tablets in water or in other media, and quick release of the active agents. Disintegration adjuvants can be employed preferably in quantities from 0.5 to 10 wt %, preferably 3 to 7 wt %, and in particular 4 to 6 wt %, based in each case on the total weight of the disintegration-adjuvant-containing agent.

Individual fragrance compounds, e.g. synthetic products of the ester, ether, aldehyde, ketone, alcohol, and hydrocarbon types, can be used in the context of the present invention as perfume oils or scents. Preferably, however, mixtures of different fragrances that together produce an attractive scent note are used. Perfume oils of this kind can also contain natural fragrance mixtures such as those accessible from plant sources, for example pine, citrus, jasmine, patchouli, rose, or ylang-ylang oil.

Automatic dishwashing agents according to the present invention can be formulated in various ways. The agents can be present in solid or liquid presentation forms, and as a combination of solid and liquid presentation forms. Suitable solid presentation forms are, in particular, powders, granulates, extrudates, compactates, in particular tablets. The liquid presentation forms based on water and/or on organic solvents can be present in thickened form, as gels. Agents according to the present invention can be formulated in the form of single-phase or multi-phase products. Automatic dishwashing agents having one, two, three, or four phases are particularly preferred. Automatic dishwashing agents, characterized in that they are present in the form of a prefabricated dispensing unit having two or more phases, are particularly preferred. The individual phases of multi-phase agents can exhibit the same or different aggregate states. Automatic dishwashing agents that comprise at least two different solid phases and/or at least two liquid phases and/or at least one solid and at least one solid phase are particularly preferred.

Automatic dishwashing agents according to the present invention are preferably pre-formulated into dispensing units. These dispensing units preferably comprise the quantity of substances having washing or cleaning activity that is necessary for one cleaning cycle. Preferred dispensing units have a weight between 12 and 30 g, preferably between 14 and 26 g, and in particular between 16 and 22 g. In order to achieve an optimal cleaning and rinsing result, those automatic dishwashing agents which are present in the form of a prefabricated dispensing unit and contain between 0.001 and 1 g, preferably between 0.01 and 0.1 g, particularly preferably between 0.01 and 0.07 g, and in particular between 0.01 and 0.05 g of polymer a), or between 0.1 and 2.5 g, preferably between 0.2 and 2.2 g, particularly preferably between 0.3 and 1.9 g, and in particular between 0.4 and 1.5 g of nonionic surfactant(s) b), are preferred. The volume of the aforesaid dispensing units and their three-dimensional shape are selected with particular preference so that dispensability of the pre-formulated units via the dispensing chamber of an automatic dishwasher is ensured. The volume of the dispensing unit is therefore preferably between 10 and 35 ml, preferably between 12 and 30 ml.

The automatic dishwashing agents according to the present invention, in particular the prefabricated dispensing units, with particular preference comprise a water-soluble envelope.

A further subject of the present Application is a method for cleaning dishes in an automatic dishwasher, in which method the agent according to the present invention is dispensed into the interior of an automatic dishwasher while a dishwashing program is being executed, before the main washing cycle begins or in the course of the main washing cycle. Dispensing or introduction of the agent according to the present invention into the interior of the automatic dishwasher can occur manually, but preferably the agent is dispensed into the interior of the automatic dishwasher by means of the dispensing chamber.

A typical framework formula for a preferably usable automatic dishwashing agent, for example in tablet form, comprises the following substances:

| | |
|---|---|
| sodium tripolyphosphate | 20 to 50 wt % |
| sodium carbonate | 10 to 30 wt % |
| sodium percarbonate | 5 to 18 wt % |
| bleach activator | 0.5 to 5 wt % |
| bleach catalyst | 0.01 to 1 wt % |
| sulfopolymer | 2.5 to 15 wt % |
| polycarboxylate | 0.1 to 10 wt % |
| nonionic surfactant | 0.5 to 10 wt % |
| phosphonates | 0.5 to 5 wt % |
| amylase | 0.1 to 5 wt % |
| protease | 0.1 to 5 wt %, |

“wt %” being based in each case on the total agent.

Instead of sodium tripolyphosphate, 10 to 50 wt % citrate can in particular also be employed in the formula.

### EXEMPLIFYING EMBODIMENTS

### Example 1

### Inhibiting Color Staining of Plastic in Automatic Dishwashing Using Dishwashing Agent Tablets

Polyethylene and polypropylene breakfast trays were subjected to an automatic dishwashing method (Bosch SGS 57M22 dishwasher; 70° C. program (shortened); water hardness 21° dH). The following ballast soil was used: 15 g olive oil, 5 g vinegar essence, 80 g tomato ketchup, 3.7 g paprika spice, 3.7 g curry spice, 10 g salt.

On the one hand a commercially usual dishwashing agent tablet, and on the other hand the same commercially usual dishwashing tablet in combination with 2 grams of Grindsted Lactem P22 or in combination with 2 grams of Grindsted Acetem 70, were used to clean the breakfast trays.

The L, a, and b values for the breakfast trays were measured before and after cleaning, using a colorimeter (Datacolor DC 600-3). The ΔE value was then identified from these values. The lower the identified ΔE value, the less the staining of the tray. The results are presented in the table below:

| | ΔE value | Difference |
|---|---|---|
| PP tray - dishwashing agent tablet | 11.5 | |
| PP tray - dishwashing agent tablet + 2 g | | |
| Grindsted Lactem P22 | 9.7 | 1.8 |

| | ΔE value | Difference |
|---|---|---|
| PE tray - dishwashing agent tablet | 15.5 | |
| PE tray - dishwashing agent tablet + 2 g | | |
| Grindsted Acetem 70 | 12.8 | 2.7 |

The values obtained confirm that by adding the glycerol esters it was possible to appreciably decrease staining of the plastic trays.

### Example 2

### Inhibiting Color Staining of Plastic in Automatic Dishwashing Using Dishwashing Agent Powder

Polypropylene breakfast trays were subjected to an automatic dishwashing method (Bosch SGS 57M22 dishwasher; 70° C. program (shortened); water hardness 21° dH). The following ballast soil was used: 15 g olive oil, 5 g vinegar essence, 80 g tomato ketchup, 3.7 g paprika spice, 3.7 g curry spice, 10 g salt.

On the one hand a commercially usual dishwashing agent powder, and on the other hand the same commercially usual dishwashing powder in combination with 2 grams of Grindsted Lactem P22 or in combination with 2 grams of Grindsted Acetem 70, were used to clean the breakfast trays.

The L, a, and b values for the breakfast trays were measured before and after cleaning, using a colorimeter (Datacolor DC 600-3). The ΔE value was then identified from these values. The lower the identified ΔE value, the less the staining of the tray. The results are presented in the table below:

| | ΔE value | Difference |
|---|---|---|
| PP tray - dishwashing agent powder | 16.1 | |
| PP tray - dishwashing agent powder + 2 g | 10.8 | 5.3 |
| Grindsted Lactem P22 | | |
| PP tray - dishwashing agent powder + 2 g | 13.7 | 2.4 |
| Grindsted Acetem 70 | | |

The values obtained confirm that by adding the glycerol esters it was possible to appreciably decrease staining of the plastic trays.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A washing or cleaning agent containing at least one glycerol ester, wherein the glycerol in the glycerol ester is esterified with one or two branched or unbranched, saturated or unsaturated C₅₋₂₁ fatty acids.

2. The washing or cleaning agent according to claim 1, wherein the C₅₋₂₁ fatty acid is a C₁₂₋₂₀ fatty acid.

3. The washing or cleaning agent according to claim 1, wherein the remaining hydroxy groups of the glycerol are unoccupied.

4. The washing or cleaning agent according to claim 1, wherein at least one further hydroxy group of the glycerol is esterified with a C₂₋₆ carboxylic acid.

5. The washing or cleaning agent according to claim 4, wherein the C₂₋₆ carboxylic acid comprises at least one further hydrophilic group selected from carboxy groups and hydroxy groups.

6. The washing or cleaning agent according to claim 4, wherein the C₂₋₆ carboxylic acid is selected from the group consisting of acetic acid, propionic acid, lactic acid, oxalic acid, citric acid, isocitric acid, tartaric acid, tartronic acid, glycolic acid, malic acid, and gluconic acid.

7. The washing or cleaning agent according to claim 1, wherein it is an automatic dishwashing agent that comprises at least one further constituent selected from the group consisting of builders, surfactants, polymers, bleaching agents, bleach activators, enzymes, glass corrosion inhibitors, corrosion inhibitors, disintegration adjuvants, scents, and perfume carriers.

8. The washing or cleaning agent according to claim 1, wherein the glycerol ester is contained in a quantity from 0.05 to 30 wt %.

9. An automatic dishwashing method, wherein a washing or cleaning agent according to claim 1 is dispensed in an automatic dishwasher while a dishwashing program is being executed.
